(19) United States
(12) Patent Application Publication
(10) Pub. No.: US 2007/0297950 A1
(43) Pub. Date: Dec. 27, 2007

(54) Equilibration device

(75) Inventors: Remo Anton Hochstrasser, Oberwil (CH); Dieter Voegelin, Sissach (CH); Urs Schwitter, Reinach (CH); Pirmin Hidber, Basel (CH)

Correspondence Address: MINTZ LEVIN COHN FERRIS GLOVSKY & POPEO, 666 THIRD AVENUE, NEW YORK, NY, 10017, US

(73) Assignee: F. Hoffmann-La Roche AG, Basel (CH)

(21) Appl. No.: 11/818,597

(22) Filed: Jun. 14, 2007

(30) Foreign Application Priority Data
Jun. 27, 2006 (EP) 06405276.4

(51) Int. Cl. B01L 3/00

(52) U.S. Cl. 422/102

(57) ABSTRACT

An equilibration device for equilibrating a comparably economic equilibration of a fluid. A first sealing layer is adjacent to the surface side between the plate and the cover. A second sealing layer is arrangeable adjacent to the cover between the plate and the cover and a tube with an open end, which is inside the well such that the open end of the tube projects above the opening of the well. The use of two sealing layers in the equilibration device allows combining the advantages of a material of the first sealing layer, e.g. high flexibility to seal uneven areas and to compensate the step formed by the tube projecting above the opening of the well, as well as the advantages of the second sealing layer, e.g. inexpensiveness, can come to combined effect when the two sealing layers are arranged appropriately.

### TECHNICAL FIELD

The present invention relates to an equilibration device for equilibrating a fluid, and more particularly to a system for stirring fluids.

### BACKGROUND ART

Particularly in chemical, biochemical and pharmaceutical industry and research, various processes for creating products involve fluids comprising several reactants. In this context, reactants comprise liquid components, solid components, gel components and (micro) biological material. To achieve an essentially complete reaction the fluid has to be equilibrated under predefined conditions as for example temperature and pressure.

For such equilibration, standardized multi-well microplates can be used being widespread in chemical, biochemical and pharmaceutical industry and research. In particular, microplates according to the standards developed by the Society for Biomolecular Screening (SBS) and approved by the American National Standards Institute (ANSI) are commonly used. The standards define microplates of 127.76 mm length, 85.48 mm width and 14.35 mm height comprising 96, 384 or 1536 wells [see Society for Biomolecular Screening. ANSI/SBS 1-2004: Microplates—Footprint Dimensions, ANSI/SBS 2-2004: Microplates—Height Dimensions, ANSI/SBS 3-2004: Microplates—Bottom Outside Flange Dimensions and ANSI/SBS 4-2004: Microplates—Well Positions. http://www.sbsonline.org: Society for Biomolecular Screening, 2004.].

Using such a microplate for equilibration of a fluid, a tube is preferably arranged inside a well of the microplate and the fluid is filled into the tube. The tube is preferably made of an inert material, such as for example glass. Typically, it projects above the well to ensure that the fluid is not in direct contact with the microplate. After filling fluid into the tube, the microplate can be closed by a cover plate and the fluid can be held inside the microplate for a predefined time period under predefined temperature and pressure conditions. In order to prevent pressure-loss, leakage of fluid out of the tube and contamination of the fluid being inside the tube, the microplate has to be tightly closed such that it is impervious to gas and liquids. For that reason, usually a sealing mat is arranged between the microplate and the cover plate.

Further, the cover plate typically has access through holes corresponding to the wells of the microplate. After equilibration, an extraction needle can be inserted into the tube through the according through hole into the tube and the fluid can be removed from the tube without opening the microplate in order to prevent adverse affection of the fluid, e.g. by contamination by air. Thereto, the sealing mat is penetrated by the needle such that the needle is kept in sealed contact with the sealing mat.

The material of the sealing mat has to fulfil various requirements. On one hand it has to be inert in respect of the fluid and resistant to the mentioned temperature and pressure conditions. On the other hand it has to be flexible enough to securely tighten the opening of the tube being arranged inside the well and projecting above the well. Materials fulfilling said requirements are usually comparably expensive. Since the sealing mats are penetrated by the extraction needle, they usually can not be reused, which causes the equilibration as described above to be comparably expensive.

Therefore, there is a need for an equilibration device allowing a comparably economic equilibration of a fluid.

### DISCLOSURE OF THE INVENTION

According to the invention this need is settled by an equilibration device for equilibrating a comparably economic equilibration of a fluid.

In particular, the invention deals with an equilibration device for equilibrating a fluid comprising a plate with a well, wherein an opening of the well is arranged at a surface side of the plate. The equilibration device comprises a cover for covering the surface side of the plate and a first sealing layer being arrangeable adjacent to the surface side between the plate and the cover. Further, it comprises a second sealing layer being arrangeable adjacent to the cover between the plate and the cover and a tube with an open end, wherein the tube is arrangeable inside the well, such that the open end of the tube projects above the opening of the well. Still further, the first sealing layer of the equilibration device has a through hole and is arrangeable such that a border of the through hole is arranged on a border of the open end of the tube when the tube is arranged inside the well. As described above, the plate can be a standardized multi-well microplate having a plurality of wells.

The use of two sealing layers in the equilibration device allows combining advantages of both single sealing layers. For example, in order to seal rather uneven areas between the plate and the cover, such as the surface side of the plate together with parts projecting above the surface side, the first sealing layer can be made of a comparably expensive, highly flexible, inert, first material. Because areas between the surface side and the cover may be exposed to a tool damaging the sealing layer at a certain step of the equilibration process, the first sealing layer can have openings arranged corresponding to said areas. The second sealing layer, which can be made of a comparably inexpensive, less flexible, inert, second material can cover the openings of the first sealing layer such that said areas are sealed by the second sealing layer. If in such an arrangement of the two sealing layers the tool affects the sealing layers at a certain step of the equilibration process, it damages only the second sealing layer and not the first sealing layer. Thus, the advantages of the first material, e.g. high flexibility to seal uneven areas, as well as the advantages of the second material, e.g. inexpensiveness, can come to combined effect. Therefore, the equilibration process can be essentially more economic using an equilibration device according to the invention.

In addition to the open end, the tube of the equilibration device can as well have a closed end such that any contact between the fluid and the plate can be prevented when the tube is arranged inside the well and the fluid is arranged inside the tube. Like this, the material of the plate can be independent of the characteristics of the fluid and the material of the tube can be selected according to these characteristics. Since the open end of the tube projects above the opening of the well it can be assured that the fluid and the plate do not come into contact, particularly not during filling the fluid into the tube or during removing the fluid out of the tube.

After equilibration, the fluid is frequently removed out of the tube for example by means of a needle. Using such first sealing layer with a through hole as described above allows accessing the fluid inside the tube without harming the first sealing layer. Since the border of the through hole of the first sealing layer is arranged on the border of the tube projecting above the opening of the well, the step formed by the projection of the tube above the plate can be compensated for example by a highly flexible first sealing layer. Thus, an effective sealing of the plate can be assured.

Preferably, the first sealing layer is made of an elastomeric material or the second sealing layer is made of polytetrafluoroethylene, preferably of polytetrafluoroethylene coated silicone, or the first sealing layer is made of an elastomeric material and the second sealing layer is made of polytetrafluoroethylene, preferably of polytetrafluoroethylene coated silicone. Using a first sealing layer made of a comparably expensive, reactant resistant, elastomeric material which is highly flexible, such as for example perfluoroelastomere, allows the first sealing layer to compensate uneven sections of the surface side of the plate. Particularly, the sections where the tube projects above the opening of the well can be efficiently compensated by such a first sealing layer. A second sealing layer made of comparably inexpensive polytetrafluoroethylene or preferably made of comparably inexpensive polytetrafluoroethylene coated silicone, can be used to cover the first sealing layer. Particularly, the areas being exposed to a tool damaging the sealing layer at a certain step of the equilibration process can be covered by such a second sealing layer. The reactant resistant polytetrafluoroethylene of the second layer is thereby arranged adjacent to the first sealing layer such that the fluid can only contact the polytetrafluoroethylene of the second sealing layer and not the silicone. After equilibration, the second sealing layer being damaged can be replaced by a new second sealing layer, wherein the first sealing layer can be reused.

Preferably, the tube is made of glass. Glass is a material which is inert for many reactants, comparably inexpensive to produce and easy to handle.

The second sealing layer is preferably arrangeable such that the through hole of the first sealing layer is covered by the second sealing layer. To avoid contamination of the fluid when removing the fluid, e.g. contamination by air while the sealing layer is taken off the plate, the sealing layer is typically penetrated by the needle such that the equilibration device does not have to be opened. Using two sealing layers, wherein the first sealing layer having a through hole is arranged as described above, only the second sealing layer has to be penetrated. Thus, the first sealing layer is not damaged and can be reused.

Preferably, the cover has a through hole being arrangeable corresponding to the opening of the well. With such a cover, the fluid can be removed from the well without removing the cover from the plate. This minimizes the possibility of contamination of the fluid and assures a convenient removing of the liquid.

In a preferred embodiment, the equilibration device comprises a stir bar being arrangeable essentially along a longitudinal axis of the tube inside the tube, wherein the stir bar is made of a ferromagnetic material. Such a stir bar can be used to conveniently mix the fluid during equilibration.

A further aspect of the invention deals with a system for stirring fluids being arranged inside wells of the equilibration device described above wherein the equilibration device has a plurality of wells. A stir bar is arranged in each of the wells and the system comprises one single moveable magnetic dipole with two opposite magnetic poles for operating all of the stir bars when the magnetic dipole is moving.

The stir bars are made of a ferromagnetic material, such that they are alternatingly attracted and rejected by the moving, e.g. rotating, magnetic dipole depending on the position of the two poles. Thus, all stir bars are moving while the magnetic dipole is moving and the fluids being arranged inside the wells are mixed by these moving stir bars. According to the described system of the invention, one single moving magnetic dipole is sufficient to operate all of the plurality of stir bars inside the wells.

The stir bars and the magnetic dipole of the system according to the invention could as well be used in other applications of multi-well plates, such as any multi-well microplates as described above, when mixing inside a plurality of wells is needed.

### BRIEF DESCRIPTION OF THE DRAWINGS

The equilibration device and the system according to the invention are described in more detail hereinbelow by way of an exemplary embodiment and with reference to the attached drawings, in which:

FIG. 1 shows a perspective exploded view on an equilibration device according to the invention;

FIG. 2 shows top view onto the equilibration device from FIG. 1 in a locked state; and

FIG. 3 shows a system according to the invention including an exploded cross-section along the line A-A of the equilibration device from FIG. 2, a symbolic cross section of a stir bar and a symbolic cross section of a magnetic dipole.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways where particular configurations, process steps, and materials disclosed herein as such configurations, process steps, and materials may vary somewhat. In addition, it is to be understood that the phraseology and terminology employed herein are for the purpose of the description and should not be regarded as limiting. Furthermore, as will be apparent to those skilled in the art, the present invention may be embodied in other specific forms without departing from the essential characteristics thereof.

For purposes of the description of the drawings and the embodiments of the present invention, as mentioned for each drawing, each figure is not drawn to scale. Some areas are drawn to be bigger and/or simpler in order to clearly portray the improvement to what has already been established. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed. It is also to be understood that the terminology employed herein is used for the purpose of describing particular embodiments only and is not intended to be limiting since the scope of the present invention will be limited only by the appended claims and equivalents thereof.

In the following description certain terms are used for reasons of convenience and are not to be interpreted as limiting. The terms “right”, “left”, “up”, “down”, “under” and “above” refer to directions in the figures. The terminology comprises the explicitly mentioned terms as well as their derivations and terms with a similar meaning.

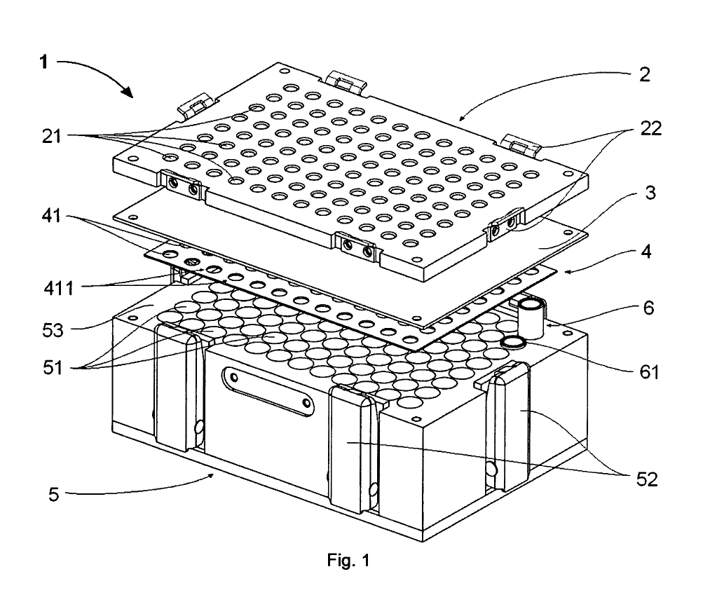

In FIG. 1 an equilibration device 1 is shown comprising a cover 2 and a plate, wherein the plate is a standard compliant multi-well microplate 5 having ninety-six wells 51 and the cover 2 is a corresponding microplate having ninety-six conical through holes 21. The openings of the wells 51 are arranged at a surface side 53 of the multi-well microplate 5. Inside the wells 51 tubes 6 having an open end with a border 61 and a closed end are arranged with the open end up wherein in FIG. 1 two tubes 6 are exemplary shown. The left one of these two tubes 6 is shown arranged inside one of the wells 51 and the right one of these two tubes 6 is shown partly inside one of the wells 51. Between the multi-well microplate 5 and the cover 2 a first and a second sealing layer is arranged wherein the first sealing layer is a lower sealing mat 4 being arranged adjacent to the surface side 53 of the multi-well microplate 5 and the second sealing layer is an upper sealing mat 3 being arranged adjacent to the cover 2 on top of the lower sealing mat 4. The lower sealing mat 4 has ninety-six through holes 41 corresponding to the ninety-six through holes 21 of the cover 2 and to the ninety-six wells 51 of the multi-well microplate 5. At the outer sides of the multi-well microplate 5 six locking members 52 are arranged around the multi-well microplate 5. The cover 2 has six locking bows 22 corresponding to the six locking member 52 of the multi-well microplate 5.

In use, the tubes 6 are filled with fluids to equilibrate. In order to be capable of selecting any suitable material for the fabrication of the multi-well microplate 5 independent of the fluids to equilibrate inside the wells 51, these tubes 6 project above the openings of the wells 51 such that any contact between the fluid and the multi-well microplate 5 can be avoided (see particularly the left of the two tubes 6 shown in FIG. 1). The tubes 6 are made of glass which is an inert material for plenty of chemical and biochemical reactions which is comparably easy to fabricate.

To be capable of compensating the steps of the tubes 6 projecting above the openings of the wells 51 when being arranged inside the wells 51, the lower sealing mat 4 is made of a highly flexible, solvent resistant elastomeric material, such as for example perfluoroelastomere, which is comparably expensive. The border 411 of each of the through holes 41 is arranged on top of the border 61 of the corresponding tube 6, thereby compensating the step. The upper sealing mat 3 closing the through holes 41 of the lower sealing mat 4 is made of polytetrafluoroethylene coated silicone, which is a solvent resistant, less flexible, but comparably inexpensive material. The restricted flexibility of the upper sealing mat 3 is sufficient for a complete sealing since the uneven areas of the surface side 53 of the multi-well microplate 5, i.e. the tubes 6 projecting above the openings of the wells 51, are compensated by the lower sealing mat 4.

In use, the equilibration device 1 is closed while the fluids are equilibrated by locking the cover 2 on top of the multi-well microplate 5. For locking, the locking members 52 are firstly swung out. Then each of the locking members 52 engages into the corresponding locking bow 22 and is forced down until it snaps in such that the cover is pushed onto the sealing mats 3 and 4 and onto the multi-well microplate 5. Thus, the equilibration device 1 is safely closed.

After equilibration, a needle is inducted into one of the through holes 21 of the cover 2 for accessing the fluid being arranged inside the corresponding well 51 of the closed and locked equilibration device 1. The conical shape of the through holes 21 of the cover 2 assists the needle to be properly inducted into the equilibration device 1. While being inducted into said well 51, the upper sealing mat 3 is penetrated and damaged by the needle. In contrast to this the lower sealing mat 4 is not damaged since the needle is inducted through one of its through holes 41. Therefore, the damaged upper sealing mat 3 has to be replaced after all fluids are removed from the equilibration device 1, but the lower sealing mat 4 can be reused.

The following applies to the rest of this description. If, in order to clarify the drawings, a figure contains reference signs which are not explained in the directly associated part of the description, then it is referred to previous description sections.

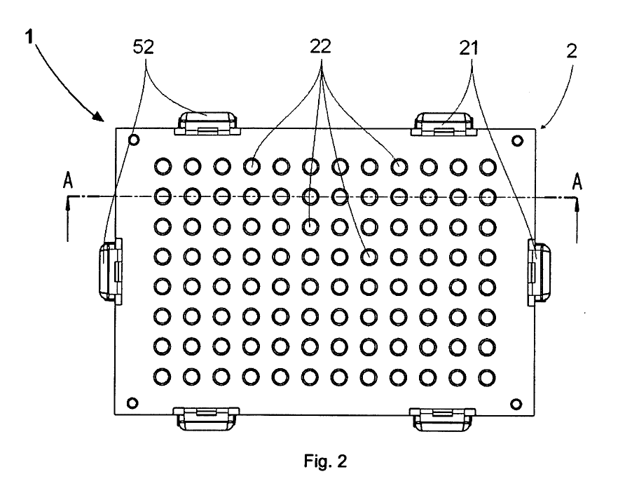

In FIG. 2 the equilibration device 1 is shown wherein the locking members 52 are engaged into the locking bows 22 and are snapped in. This locking assures on one hand a secure closing of the multi-well microplate 5 such that the handling of the equilibration device 1 can be improved. On the other hand, it assures that the cover 2 is pushed onto the multi-well microplate 5 with a certain predefined force such that the upper sealing mat 3 and the lower sealing mat 4 are compressed. This assures a proper sufficient sealing of the multi-well microplate 5, particularly of its uneven areas, enabling a preferred equilibration process under preferred conditions.

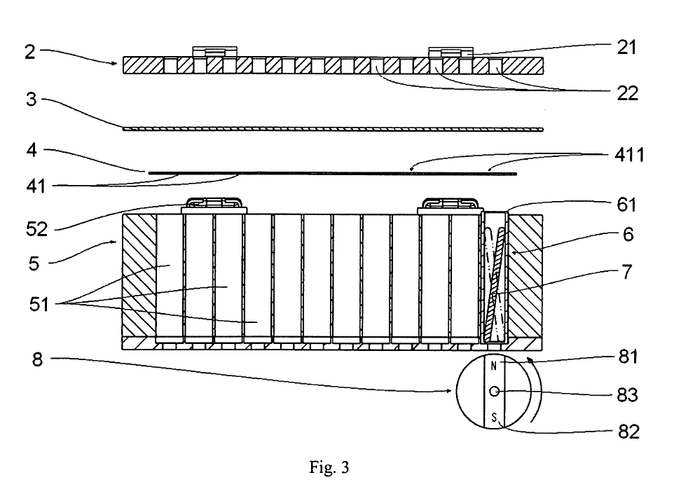

FIG. 3 shows a cross section view of a system according to the invention comprising the equilibration device 1 described above, a stir bar 7 made of a ferromagnetic material and a magnetic dipole 8. The stir bar 7 is arranged essentially along a longitudinal axis of the tube 6 inside the tube 6 wherein it is inclined against a wall of the tube 6 due to gravitation while the system is not stirring. As indicated by the dotted line, the stir bar 7 could as well be inclined against any other wall of the tube 6. The magnetic dipole 8 has a cylindrical body wherein a longitudinal band of the superficies surface of the magnetic dipole 8 is a magnetic north pole 81 and another longitudinal band on the opposite side of the superficies surface of the magnetic dipole 8 is a magnetic south pole 82. As indicated by the arrow in FIG. 3, the magnetic dipole 8 is rotatable around its longitudinal axis 83. In FIG. 3 the magnetic dipole 8 is schematically shown in an off-center position below a right side of the multi-well microplate 5 wherein the axis 83 of the magnetic dipole 8 is arranged parallel to the width of the multi-well microplate 5. The magnetic dipole 8 can as well be arranged in other ways than shown in FIG. 3. Preferably, it is arranged centered below the multi-well microplate 5 wherein the axis 83 of the magnetic dipole 8 is arranged parallel to the length of the multi-well microplate 5.

In use, for mixing the fluids being arranged inside the tubes 6, the magnetic dipole 8 rotates around its axis 83. The stir bars 7 being arranged inside the wells 51 are thereby alternatingly attracted and rejected by the magnetic dipole 8 depending on the position of the two poles 81 and 82. Thus, the stir bars 7 moves inside the tubes 6 such that the fluids are mixed. Depending on the properties of the fluids, the rotation speed of the magnetic dipole 8, the magnetic force of the magnetic dipole 8 and the arrangement of the stir bars 7 can be adapted to achieve an appropriate mixing.

Other alternative embodiments of the equilibration device according to the invention and the system according to the invention are conceivable. Explicitly mentioned in this context are:

Additional sealing layers can be arranged between the plate and the cover for combining advantages of all of the sealing layers.

The magnetic dipole can be of any shape and can be moved in any manner causing a movement of the stir bars appropriate for mixing the fluids.

What is claimed is:

1. An equilibration device for equilibrating a fluid, comprising:
a plate with a well,
wherein an opening of the well is arranged at a surface side of the plate;
a cover for covering the surface side of the plate;
a first sealing layer being arrangeable adjacent to the surface side between the plate and the cover;
a second sealing layer being arrangeable adjacent to the cover between the plate and the cover; and
a tube with an open end, being arrangeable inside the well such that the open end of the tube projects above the opening of the well,
wherein the first sealing layer has a through hole,
wherein the first sealing layer is arrangeable such that a border of the through hole is arranged on a border of the open end of the tube when the tube is arranged inside the well.

2. The equilibration device according to claim 1, wherein the first sealing layer is made of an elastomeric material or the second sealing layer is made of polytetrafluoroethylene, preferably of polytetrafluoroethylene coated silicone, or the first sealing layer is made of an elastomeric material and the second sealing layer is made of polytetrafluoroethylene, preferably of polytetrafluoroethylene coated silicone.

3. The equilibration device according to claim 1, wherein the tube is made of glass.

4. The equilibration device according to claim 1, wherein the second sealing layer is arrangeable such that the through hole of the first sealing layer is covered by the second sealing layer.

5. The equilibration device according to claim 1, wherein the cover has a through hole being arrangeable corresponding to the opening of the well.

6. The equilibration device according to claim 1, further comprising:
a stir bar being arrangeable essentially along a longitudinal axis of the tube inside the tube, wherein the stir bar is made of a ferromagnetic material.

7. A system for stirring fluids being arranged inside wells of an equilibration device comprising:
a plate with a plurality of wells,
wherein a stir bar is arranged in each of the wells, and
wherein the plurality of wells' openings are arranged at a surface side of the plate;
a cover for covering the surface side of the plate;
a first sealing layer being arrangeable adjacent to the surface side between the plate and the cover;
a second sealing layer being arrangeable adjacent to the cover between the plate and the cover; and
a tube with an open end, being arrangeable inside the well such that the open end of the tube projects above the opening of the well,
wherein the first sealing layer has a through hole, and
wherein the first sealing layer is arrangeable such that a border of the through hole is arranged on a border of the open end of the tube when the tube is arranged inside the well; and
one single moveable magnetic dipole with two opposite magnetic poles for operating all of the stir bars when the magnetic dipole is moving.
